(19) United States
(12) Patent Application Publication
(10) Pub. No.: US 2026/0205758 A1
(43) Pub. Date: Jul. 16, 2026

(54) BINAURAL AUDIO RENDERING OF SPATIAL AUDIO

(71) Applicant: Nokia Technologies Oy, Espoo (FI)

(72) Inventors: Mikko-Ville Laitinen, Espoo (FI); Juha Tapio Vilkamo, Helsinki (FI); Tapani Pihlajakuja, Kellokoski (FI)

(21) Appl. No.: 19/134,532

(22) PCT Filed: Nov. 6, 2023
(86) PCT No.: PCT/EP2023/080815

§ 371 Date: May 30, 2025

(30) Foreign Application Priority Data
Dec. 1, 2022 (GB) 2218103.6

(51) Int. Cl. H04S 7/00; H04S 1/00

(52) U.S. Cl. CPC H04S 7/304; H04S 1/007; H04S 2400/11

(57) ABSTRACT

A method for generating a spatial output audio signal, the method including: obtaining a spatial audio signal, the spatial audio signal including: at least two channel audio signals; and at least one spatial parameter associated with the at least two channel audio signals; analysing the at least two channel audio signals to determine at least one inter-channel property; obtaining an orientation and/or position parameter; determining mixing information based on the at least one inter-channel property and the orientation and/or position parameter; and generating at least two channel output audio signals based on the at least two channel audio signals, the orientation and/or position parameter and the mixing information.

### FIELD

the present application relates to apparatus and methods for binaural audio rendering of spatial audio, but not exclusively for generating headtracked binaural rendering with adaptive prototypes within parametric spatial audio rendering.

### BACKGROUND

There are many ways to capture spatial audio. One option is to capture the spatial audio using a microphone array, e.g., as part of a mobile device. Using the microphone signals, spatial analysis of the sound scene can be performed to determine spatial metadata in frequency bands. Moreover, transport audio signals can be determined using the microphone signals. The spatial metadata and the transport audio signals can be combined to form a spatial audio stream.

Metadata-assisted spatial audio (MASA) is one example of a spatial audio stream. It is one of the input formats the upcoming immersive voice and audio services (IVAS) codec will support. It uses audio signal(s) together with corresponding spatial metadata (containing, e.g., directions and direct-to-total energy ratios in frequency bands) and descriptive metadata (containing additional information relating to, e.g., the original capture and the (transport) audio signal(s)). The MASA stream can, e.g., be obtained by capturing spatial audio with microphones of, e.g., a mobile device, where the set of spatial metadata is estimated based on the microphone signals. The MASA stream can be obtained also from other sources, such as specific spatial audio microphones (such as Ambisonics), studio mixes (e.g., 5.1 mix) or other content by means of a suitable format conversion. It is also possible to use MASA tools inside a codec for the encoding of multichannel channel signals by converting the multichannel signals to a MASA stream and encoding that stream.

### SUMMARY

According to a first aspect there is provided a method for generating a spatial output audio signal, the method comprising: obtaining a spatial audio signal, the spatial audio signal comprising: at least two channel audio signals; and at least one spatial parameter associated with the at least two channel audio signals; analysing the at least two channel audio signals to determine at least one inter-channel property; obtaining an orientation and/or position parameter; determining mixing information based on the at least one inter-channel property and the orientation and/or position parameter; and generating at least two channel output audio signals based on the at least two channel audio signals, the orientation and/or position parameter and the mixing information.

Generating at least two channel output audio signals may further comprise generating the at least two channel output audio signals based on the at least one spatial parameter associated with the at least two channel audio signals.

Determining mixing information may further comprise determining mixing information further based on the at least one spatial parameter.

Analysing the at least two channel audio signals to determine the at least one inter-channel property may comprise generating the inter-channel property based on the at least one spatial parameter associated with the at least two channel audio signals.

The at least one spatial parameter associated with the at least two channel audio signals may comprise: a spatial parameter associated with respective ones of the at least two audio channel audio signals; and a spatial parameter associated with the at least two audio channel audio signals.

Generating at least two channel output audio signals based on the at least two channel audio signals, the at least one spatial parameter associated with the at least two channel audio signals, the orientation parameter and the mixing information may comprise: generating at least one prototype matrix based on the mixing information; rendering the at least two channel output audio signals from the at least two channel audio signals based on: the at least one spatial parameter associated with the at least two channel audio signals; the orientation parameter, the orientation parameter and the at least one prototype matrix.

Generating at least two channel output audio signals based on the at least two channel audio signals, the at least one spatial parameter associated with the at least two channel audio signals, the orientation parameter and the mixing information may comprise: processing the at least two channel audio signals based on the mixing information to generate at least two channel adapted audio signals; rendering the at least two channel output audio signals from the at least two channel adapted audio signals based on: the at least one spatial parameter associated with the at least two channel audio signals; and the orientation parameter.

Processing the at least two channel audio signals based on the mixing information to generate at least two channel adapted audio signals may comprise adapting the at least two channel audio signals based on the current orientation and the inter-channel property.

Adapting the at least two channel audio signals based on the current orientation and the inter-channel property may comprise determining a mono factor based on the current orientation and the inter-channel property, the mono factor configured to indicate how the at least two channel audio signals should be intermixed to avoid negative artefacts within the at least two channel output audio signals.

Analysing the at least two channel audio signals to determine at least one inter-channel property may comprise analysing the at least two channel audio signals to determine at least one of: inter-channel level differences between the at least two channel audio signals; modified inter-channel level differences between the at least two channel audio signals between the at least two channel audio signals, the modifications based on the orientation and/or position parameter; inter-channel phase differences between the at least two channel audio signals; inter-channel time differences between the at least two channel audio signals; inter-channel similarity measures between the at least two channel audio signals; and inter-channel correlation between the at least two channel audio signals.

Processing the at least two channel audio signals based on the mixing information to generate at least two channel adapted audio signals may comprise mixing the least two channel audio signals based on the inter-channel differences such that an audio component substantially in one of the at least two channel audio signals is mixed to a respective one of the at least two channel adapted audio signals and further at least partially cross-mixed to a further of the at least two channel adapted audio signals.

Processing the at least two channel audio signals based on the mixing information to generate at least two channel adapted audio signals may further comprise switching at least two of the generated at least two channel adapted audio signals based on the orientation and/or position parameter indicating an orientation towards a rear direction.

The at least two channel output audio signals may be binaural audio signals.

The method may further comprise obtaining a user head orientation and/or position and wherein obtaining the orientation and/or position parameter comprises processing the user head orientation and/or position to generate the orientation and/or position parameter.

According to a second aspect there is provided an apparatus for generating a spatial output audio signal, the apparatus comprising means configured to: obtain a spatial audio signal, the spatial audio signal comprising: at least two channel audio signals; and at least one spatial parameter associated with the at least two channel audio signals; analyse the at least two channel audio signals to determine at least one inter-channel property; obtain an orientation and/or position parameter; determine mixing information based on the at least one inter-channel property and the orientation and/or position parameter; and generate at least two channel output audio signals based on the at least two channel audio signals, the orientation and/or position parameter and the mixing information.

The means configured to generate at least two channel output audio signals may further be configured to generate the at least two channel output audio signals based on the at least one spatial parameter associated with the at least two channel audio signals.

The means configured to determine mixing information may further be configured to determine mixing information further based on the at least one spatial parameter.

The means configured to analyse the at least two channel audio signals to determine the at least one inter-channel property may be configured to generate the inter-channel property based on the at least one spatial parameter associated with the at least two channel audio signals.

The at least one spatial parameter associated with the at least two channel audio signals may comprise: a spatial parameter associated with respective ones of the at least two audio channel audio signals; and a spatial parameter associated with the at least two audio channel audio signals.

The means configured to generate at least two channel output audio signals based on the at least two channel audio signals, the at least one spatial parameter associated with the at least two channel audio signals, the orientation parameter and the mixing information may be configured to: generate at least one prototype matrix based on the mixing information; render the at least two channel output audio signals from the at least two channel audio signals based on: the at least one spatial parameter associated with the at least two channel audio signals; the orientation parameter, the orientation parameter and the at least one prototype matrix.

The means configured to generate at least two channel output audio signals based on the at least two channel audio signals, the at least one spatial parameter associated with the at least two channel audio signals, the orientation parameter and the mixing information may be configured to: process the at least two channel audio signals based on the mixing information to generate at least two channel adapted audio signals; render the at least two channel output audio signals from the at least two channel adapted audio signals based on: the at least one spatial parameter associated with the at least two channel audio signals; and the orientation parameter.

The means configured to process the at least two channel audio signals based on the mixing information to generate at least two channel adapted audio signals may be configured to adapt the at least two channel audio signals based on the current orientation and the inter-channel property.

The means configured to adapt the at least two channel audio signals based on the current orientation and the inter-channel property may be configured to determine a mono factor based on the current orientation and the inter-channel property, the mono factor configured to indicate how the at least two channel audio signals should be intermixed to avoid negative artefacts within the at least two channel output audio signals.

The means configured to analyse the at least two channel audio signals to determine at least one inter-channel property may be configured to analyse the at least two channel audio signals to determine at least one of: inter-channel level differences between the at least two channel audio signals; modified inter-channel level differences between the at least two channel audio signals between the at least two channel audio signals, the modifications based on the orientation and/or position parameter; inter-channel phase differences between the at least two channel audio signals; inter-channel time differences between the at least two channel audio signals; inter-channel similarity measures between the at least two channel audio signals; and inter-channel correlation between the at least two channel audio signals.

The means configured to process the at least two channel audio signals based on the mixing information to generate at least two channel adapted audio signals may be configured to mix the least two channel audio signals based on the inter-channel differences such that an audio component substantially in one of the at least two channel audio signals is mixed to a respective one of the at least two channel adapted audio signals and further at least partially cross-mixed to a further of the at least two channel adapted audio signals.

The means configured to process the at least two channel audio signals based on the mixing information to generate at least two channel adapted audio signals may further be configured to switch at least two of the generated at least two channel adapted audio signals based on the orientation and/or position parameter indicating an orientation towards a rear direction.

The at least two channel output audio signals may be binaural audio signals.

The means may be further configured to obtain a user head orientation and/or position and wherein the means configured to obtain the orientation and/or position parameter may be configured to process the user head orientation and/or position to generate the orientation and/or position parameter. According to a third aspect there is provided an apparatus for generating a spatial output audio signal, the apparatus comprising at least one processor and at least one memory storing instructions that, when executed by the at least one processor, cause the system at least to perform: obtaining a spatial audio signal, the spatial audio signal comprising: at least two channel audio signals; and at least one spatial parameter associated with the at least two channel audio signals; analysing the at least two channel audio signals to determine at least one inter-channel property; obtaining an orientation and/or position parameter; determining mixing information based on the at least one inter-channel property and the orientation and/or position parameter; and generating at least two channel output audio signals based on the at least two channel audio signals, the orientation and/or position parameter and the mixing information.

The apparatus caused to perform generating at least two channel output audio signals may further be caused to perform generating the at least two channel output audio signals based on the at least one spatial parameter associated with the at least two channel audio signals.

The apparatus caused to perform determining mixing information may further be caused to perform determining mixing information further based on the at least one spatial parameter.

The apparatus caused to perform analysing the at least two channel audio signals to determine the at least one inter-channel property may be further caused to perform generating the inter-channel property based on the at least one spatial parameter associated with the at least two channel audio signals.

The at least one spatial parameter associated with the at least two channel audio signals may comprise: a spatial parameter associated with respective ones of the at least two audio channel audio signals; and a spatial parameter associated with the at least two audio channel audio signals.

The apparatus caused to perform generating at least two channel output audio signals based on the at least two channel audio signals, the at least one spatial parameter associated with the at least two channel audio signals, the orientation parameter and the mixing information may be further caused to perform: generating at least one prototype matrix based on the mixing information; rendering the at least two channel output audio signals from the at least two channel audio signals based on: the at least one spatial parameter associated with the at least two channel audio signals; the orientation parameter, the orientation parameter and the at least one prototype matrix.

The apparatus caused to perform generating at least two channel output audio signals based on the at least two channel audio signals, the at least one spatial parameter associated with the at least two channel audio signals, the orientation parameter and the mixing information may be caused to perform: processing the at least two channel audio signals based on the mixing information to generate at least two channel adapted audio signals; rendering the at least two channel output audio signals from the at least two channel adapted audio signals based on: the at least one spatial parameter associated with the at least two channel audio signals; and the orientation parameter.

The apparatus caused to perform processing the at least two channel audio signals based on the mixing information to generate at least two channel adapted audio signals may be further caused to perform adapting the at least two channel audio signals based on the current orientation and the inter-channel property.

The apparatus caused to perform adapting the at least two channel audio signals based on the current orientation and the inter-channel property may be further caused to perform determining a mono factor based on the current orientation and the inter-channel property, the mono factor configured to indicate how the at least two channel audio signals should be intermixed to avoid negative artefacts within the at least two channel output audio signals.

The apparatus caused to perform analysing the at least two channel audio signals to determine at least one inter-channel property may be further caused to perform analysing the at least two channel audio signals to determine at least one of: inter-channel level differences between the at least two channel audio signals; modified inter-channel level differences between the at least two channel audio signals between the at least two channel audio signals, the modifications based on the orientation and/or position parameter; inter-channel phase differences between the at least two channel audio signals; inter-channel time differences between the at least two channel audio signals; inter-channel similarity measures between the at least two channel audio signals; and inter-channel correlation between the at least two channel audio signals.

The apparatus caused to perform processing the at least two channel audio signals based on the mixing information to generate at least two channel adapted audio signals may be further caused to perform mixing the least two channel audio signals based on the inter-channel differences such that an audio component substantially in one of the at least two channel audio signals is mixed to a respective one of the at least two channel adapted audio signals and further at least partially cross-mixed to a further of the at least two channel adapted audio signals.

The apparatus caused to perform processing the at least two channel audio signals based on the mixing information to generate at least two channel adapted audio signals may further be caused to perform switching at least two of the generated at least two channel adapted audio signals based on the orientation and/or position parameter indicating an orientation towards a rear direction.

The at least two channel output audio signals may be binaural audio signals.

The apparatus may be further caused to perform obtaining a user head orientation and/or position and wherein the apparatus caused to perform obtaining the orientation and/or position parameter may be further caused to perform processing the user head orientation and/or position to generate the orientation and/or position parameter.

According to a fourth aspect there is provided an apparatus for generating a spatial output audio signal, the apparatus comprising: means for obtaining a spatial audio signal, the spatial audio signal comprising: at least two channel audio signals; and at least one spatial parameter associated with the at least two channel audio signals; means for analysing the at least two channel audio signals to determine at least one inter-channel property; means for obtaining an orientation and/or position parameter; means for determining mixing information based on the at least one inter-channel property and the orientation and/or position parameter; and means for generating at least two channel output audio signals based on the at least two channel audio signals, the orientation and/or position parameter and the mixing information.

According to a fifth aspect there is provided an apparatus for generating a spatial output audio signal, the apparatus comprising: obtaining circuitry configured to obtain a spatial audio signal, the spatial audio signal comprising: at least two channel audio signals; and at least one spatial parameter associated with the at least two channel audio signals; analysing circuitry configured to analyse the at least two channel audio signals to determine at least one inter-channel property; obtaining circuitry configured to obtain an orientation and/or position parameter; determining circuitry configured to determine mixing information based on the at least one inter-channel property and the orientation and/or position parameter; and generating circuitry configured to generate at least two channel output audio signals based on the at least two channel audio signals, the orientation and/or position parameter and the mixing information.

According to a sixth aspect there is provided a computer program comprising instructions [or a computer readable medium comprising program instructions] for causing an apparatus for generating a spatial output audio signal to perform at least the following: obtaining a spatial audio signal, the spatial audio signal comprising: at least two channel audio signals; and at least one spatial parameter associated with the at least two channel audio signals; analysing the at least two channel audio signals to determine at least one inter-channel property; obtaining an orientation and/or position parameter; determining mixing information based on the at least one inter-channel property and the orientation and/or position parameter; and generating at least two channel output audio signals based on the at least two channel audio signals, the orientation and/or position parameter and the mixing information.

According to a seventh aspect there is provided a non-transitory computer readable medium comprising program instructions for causing an apparatus for generating a spatial output audio signal to perform at least the following: obtaining a spatial audio signal, the spatial audio signal comprising: at least two channel audio signals; and at least one spatial parameter associated with the at least two channel audio signals; analysing the at least two channel audio signals to determine at least one inter-channel property; obtaining an orientation and/or position parameter; determining mixing information based on the at least one inter-channel property and the orientation and/or position parameter; and generating at least two channel output audio signals based on the at least two channel audio signals, the orientation and/or position parameter and the mixing information.

According to an eighth aspect there is provided a computer readable medium comprising program instructions for causing an apparatus for generating a spatial output audio signal to perform at least the following: the method comprising: obtaining a spatial audio signal, the spatial audio signal comprising: at least two channel audio signals; and at least one spatial parameter associated with the at least two channel audio signals; analysing the at least two channel audio signals to determine at least one inter-channel property; obtaining an orientation and/or position parameter; determining mixing information based on the at least one inter-channel property and the orientation and/or position parameter; and generating at least two channel output audio signals based on the at least two channel audio signals, the orientation and/or position parameter and the mixing information.

An apparatus comprising means for performing the actions of the method as described above.

An apparatus configured to perform the actions of the method as described above.

A computer program comprising program instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically an example system of capture and playback of spatial audio signals suitable for implementing some embodiments;

FIG. 2 shows a flow diagram of the operation of the example system of capture and playback of spatial audio signals capture apparatus shown in FIG. 1 according to some embodiments;

FIG. 3 shows schematically an example system of apparatus suitable for implementing some embodiments;

FIG. 4 shows schematically an example playback apparatus as shown in FIG. 1 suitable for implementing some embodiments;

FIG. 5 shows a flow diagram of the operation of the example playback apparatus shown in FIG. 4 according to some embodiments;

FIG. 6 shows schematically a spatial processor as shown in FIG. 4 according to some embodiments;

FIG. 7 shows a flow diagram of the operation of the spatial processor shown in FIG. 6 according to some embodiments;

FIG. 8 shows schematically an example transport signal adaptor as shown in FIG. 6 according to some embodiments;

FIG. 9 shows a flow diagram of the operation of the example transport signal adaptor shown in FIG. 8 according to some embodiments;

FIG. 10 shows example processing outputs; and

FIG. 11 shows schematically a further example capture and playback system of apparatus suitable for implementing some embodiments.

### EMBODIMENTS OF THE APPLICATION

The following describes in further detail suitable apparatus and possible mechanisms for the rendering of suitable output audio signals from parametric spatial audio streams (or signals) from captured or otherwise obtained audio signals.

As discussed above Metadata-Assisted Spatial Audio (MASA) is an example of a parametric spatial audio format and representation suitable as an input format for IVAS.

It can be considered an audio representation consisting of ‘N channels+spatial metadata’. It is a scene-based audio format particularly suited for spatial audio capture on practical devices, such as smartphones. The idea is to describe the sound scene in terms of time- and frequency-varying sound directions and, e.g., energy ratios. Sound energy that is not defined (described) by the directions, is described as diffuse (coming from all directions).

As discussed above spatial metadata associated with the audio signals may comprise multiple parameters (such as multiple directions and associated with each direction (or directional value) a direct-to-total ratio, spread coherence, distance, etc.) per time-frequency tile. The spatial metadata may also comprise other parameters or may be associated with other parameters which are considered to be non-directional (such as surround coherence, diffuse-to-total energy ratio, remainder-to-total energy ratio) but when combined with the directional parameters are able to be used to define the characteristics of the audio scene. For example a reasonable design choice which is able to produce a good quality output is one where the spatial metadata comprises one or more directions for each time-frequency portion (and associated with each direction direct-to-total ratios, spread coherence, distance values etc) are determined.

As described above, parametric spatial metadata representation can use multiple concurrent spatial directions. With MASA, the proposed maximum number of concurrent directions is two. For each concurrent direction, there may be associated parameters such as: Direction index; Direct-to-total ratio; Spread coherence; and Distance. In some embodiments other parameters such as Diffuse-to-total energy ratio; Surround coherence; and Remainder-to-total energy ratio are defined.

The parametric spatial metadata values are available for each time-frequency tile (the MASA format defines that there are 24 frequency bands and 4 temporal sub-frames in each frame). The frame size in IVAS is 20 ms. Furthermore currently MASA supports 1 or 2 directions for each time-frequency tile.

Example metadata parameters can be:
Format descriptor which defines the MASA format for IVAS;
Channel audio format which defines a combined following fields stored in two bytes;
Number of directions which defines a number of directions described by the spatial metadata (Each direction is associated with a set of direction dependent spatial metadata as described afterwards);
Number of channels which defines a number of transport channels in the format;
Source format which describes the original format from which MASA was created.

Examples of the MASA format spatial metadata parameters which are dependent of number of directions can be:
Direction index which defines a direction of arrival of the sound at a time-frequency parameter interval. (typically this is a spherical representation at about 1-degree accuracy);
Direct-to-total energy ratio which defines an energy ratio for the direction index (i.e., time-frequency subframe); and
Spread coherence which defines a spread of energy for the direction index (i.e., time-frequency subframe).
Examples of MASA format spatial metadata parameters which are independent of number of directions can be:
Diffuse-to-total energy ratio which defines an energy ratio of non-directional sound over surrounding directions;
Surround coherence which defines a coherence of the non-directional sound over the surrounding directions;
Remainder-to-total energy ratio which defines an energy ratio of the remainder (such as microphone noise) sound energy to fulfil requirement that sum of energy ratios is 1.

Furthermore example spatial metadata frequency bands can be

| | LF | HF | BW |
|---|---|---|---|
| Band | (Hz) | (Hz) | (Hz) |
| 1 | 0 | 400 | 400 |
| 2 | 400 | 800 | 400 |
| 3 | 800 | 1200 | 400 |
| 4 | 1200 | 1600 | 400 |
| 5 | 1600 | 2000 | 400 |
| 6 | 2000 | 2400 | 400 |
| 7 | 2400 | 2800 | 400 |
| 8 | 2800 | 3200 | 400 |
| 9 | 3200 | 3600 | 400 |
| 10 | 3600 | 4000 | 400 |
| 11 | 4000 | 4400 | 400 |
| 12 | 4400 | 4800 | 400 |
| 13 | 4800 | 5200 | 400 |
| 14 | 5200 | 5600 | 400 |
| 15 | 5600 | 6000 | 400 |
| 16 | 6000 | 6400 | 400 |
| 17 | 6400 | 6800 | 400 |
| 18 | 6800 | 7200 | 400 |
| 19 | 7200 | 7600 | 400 |
| 20 | 7600 | 8000 | 400 |
| 21 | 8000 | 10000 | 2000 |
| 22 | 10000 | 12000 | 2000 |
| 23 | 12000 | 16000 | 4000 |
| 24 | 16000 | 24000 | 8000 |

The MASA stream can be rendered to various outputs, such as multichannel loudspeaker signals (e.g., 5.1) or binaural signals.

One example rendering method is described in Vilkamo, J., Bäckström, T., & Kuntz, A. (2013). Optimized covariance domain framework for time-frequency processing of spatial audio. Journal of the Audio Engineering Society, 61 (6), 403-411. The rendering method is based on multi-channel mixing. The method processes the given audio signals in frequency bands so that a desired covariance matrix is obtained for the output signal in frequency bands. The covariance matrix contains the channel energies of all channels and inter-channel relationships between all channel pairs, namely the cross-correlation and the inter-channel phase differences. These features are known to convey the perceptually relevant spatial features of a multi-channel sound in various playback situations, such as binaurally for headphones, surround loudspeakers, Ambisonics, and cross-talk-cancelled stereo.

The rendering method indicated above employs a prototype signal (or a prototype matrix that provides the prototype signal based on the input signal). The prototype signal or matrix can be frequency invariant or frequency variant, depending on the use case. The prototype signal is a signal that, for an output channel, provides an example signal of “what kind of signal content should the channel have”.

Such information is needed, since the covariance matrix only expresses the spatial image, but not what kind of sounds arrive from different directions. For example, if in a frequency band there is a tone at one direction, and narrowband noise at another direction, the covariance matrix could be the same or highly similar even if these channels would be reversed, assuming that these signals have the same energy. Therefore, the rendering method employs a prototype matrix or a prototype signal to guide the rendering of the spatial output. The rendering method discusses providing an output with the desired covariance matrix characteristics, but so that the output signal waveform maximally resembles the prototype signal.

There are also other parametric rendering schemes. Nevertheless, typically they use in some way prototype signals for the rendering, i.e., the rendering is based on the transmitted audio signals, and they are modified in frequency bands based on the spatial metadata to obtain the desired spatial audio signals (such as binaural signals).

The above examples use the terms “prototype signal” and “prototype matrix”. As a generalization, these terms refer to pre-processing of the transport audio signals to provide audio signals suitable for the spatial audio rendering. In some examples the prototype signal is the transport audio signals, in other words there is no processing of the transport audio signals to generate the prototype signals.

The embodiments as discussed herein focus on head-tracked binaural reproduction (however other embodiments may employ the methods for other multichannel reproduction formats without significant inventive input). In the following examples the transport audio signal (the audio signal generated from the capture apparatus) can be a two-channel transport signal with the left channel containing sounds that are mostly at left within an acoustic audio environment, and the right channel containing sounds that are mostly at right within an acoustic audio environment. For example, these signals could be obtained from two coincident cardioid microphones pointing towards left and right directions. Such a signal is in general favourable for generating a binaural signal. The left and right binaural audio channels can be synthesized predominantly based on the corresponding left and right transport signals. The spatial processing synthesizes the desired binaural cues, and the fine spectral content of the left and right ears tends to follow that of the transport audio signals.

When the listener or user of the playback apparatus turns their head more than 90 degrees, the left transport audio channel signal resembles more the sounds that are meant for the right ear, and vice versa. Using such a signal as the starting point of the spatial synthesis, the rendering method described above could render the appropriate covariance matrix for the binaural signals, but performs poorly in many situations, because the fine spectral content of the left and right binaural signals poorly matches the intended content. The sound may further obtain vocoder-like characteristics, since even though the channel energies are appropriately synthesized, the fine spectral content is predominantly of the wrong origin.

Although, such as disclosed in GB2007904.2, the left and right transport channels can be flipped to improve performance when the user is looking close to 180 degrees to the original viewing directions (i.e., they are looking towards the ‘back’ direction), this flipping of transport channels performs poorly in other directions, such as when the user is orientated towards directions near ±90 degrees.

For example the stereo transport sound was obtained with two cardioids pointing towards left and right. This means that any sound directly from left or right will be only in one of these channels. This is a situation where channel flipping does not help, since one of the transport signals does not contain the aforementioned signal at all. Having a source at 90 degrees and user head orientation of 90 degrees, the sound is to be rendered approximately at centre, i.e., at same level at both ears. The spatial renderer synthesizes such binaural cues, but it could do so by amplifying the wrong signal content, as that particular signal content may be missing at one of the channels. In other words, the rendering method as shown above is given a poor starting point to render the binaural output, and in these situations the perceived sound quality is often poor.

Although, it would be possible to mix the transport signal to a dual mono signal before the spatial synthesis and thus the desired signal would always be available for both binaural outputs, this would mean also losing the inherent incoherence between the transport channels, which is needed for rendering ambience (or width in general) without using significant amount of audio decorrelation processing, which is detrimental for the sound quality for signals such as applause or speech.

The IVAS use case (e.g., the MASA format) makes the situation even more complex, since the cardioid example is only one of many potential transport-signal format types. The transport signals may be, for example, a downmix of a 5.1 channel format sound, or generated from spaced microphones with or without significant directional characteristics.

The following embodiments and the concept generally as discussed in the application herein is one of enabling an efficient method for adapting the transport audio signals for the spatial audio rendering to be suitable for any head orientation and any transport signal type. As a result, the sound quality produced in such a manner would be superior in certain head orientations and/or with certain transport signal types. These embodiments thus create a good user experience, as the quality of sound is maintained independent of the head position/turn of the user.

In summary the concept as discussed in further detail in the embodiments hereafter relates to head-tracked binaural rendering of parametric spatial audio composed of spatial metadata and transport audio signal(s). In some embodiments this can be where the transport audio signals is at least two different types. In such embodiments there is provided a binaural renderer that can render binaural audio from transport audio signals and spatial metadata, to achieve high-quality (accurate directional reproduction and no significant added noises) head-tracked rendering of binaural audio from transport audio signals (having at least 2 channels) with arbitrary inter-channel features (such as the directional patterns and the spacing of the microphones), in any orientation of the head. In some embodiments this can be achieved by determining inter-channel features based on analysis of the transport audio signals (such as the level differences in frequency bands), then determining mixing information based on the determined inter-channel features and the orientation of the head. This mixing information can then enable the mixing of the transport audio signals to obtain two audio signals (sometimes called “prototype signals”) that represent suitable audio signal content for the left and right output channels. Then the embodiments can furthermore be configured to perform rendering binaural audio using the determined mixing information, the head orientation, and the spatial metadata.

As described in further detail herein there are at least two ways the mixing information may be employed at the binaural audio rendering. In some embodiments the mixing information may be used to pre-process the transport audio signals to be suitable for the spatial audio rendering for the present head orientation and the determined inter-channel features. This approach is described in detail in the following example embodiments.

Alternatively, in some embodiments the mixing information is employed as a prototype matrix at the spatial rendering. This, for example, when the rendering method discussed earlier is used, employs the mixing information as a prototype matrix and causes the left and right binaural audio signals resemble a pre-processed version of the transport audio signals in terms of the fine spectral content in the desired manner, but that pre-processed version of the transport audio signals is in fact not generated as a separate intermediate signal (in the program memory). This approach is further described herein.

In the description herein the term “audio signal” may refer to an audio signal having one channel or an audio signal with multiple channels. When it is relevant to specify that a signal has one or more channels, it is stated explicitly. Furthermore, the term “audio signal” can mean that the signal is in any form, such as an encoded or non-encoded form, e.g., a sequence of values defining a signal waveform or spectral values.

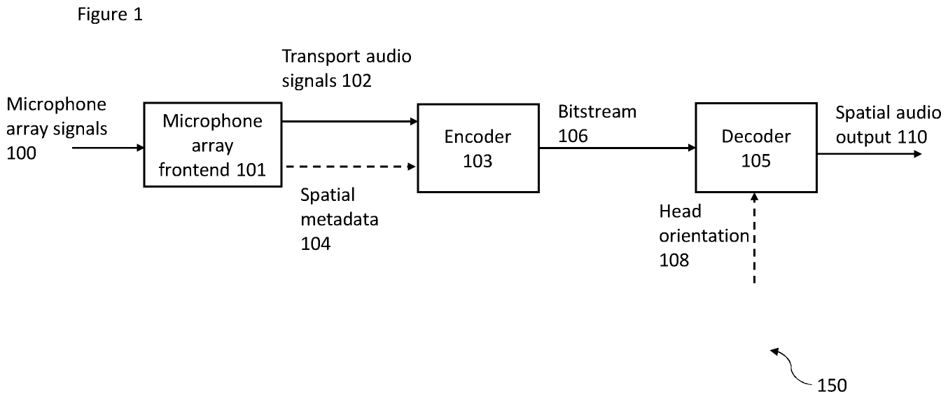

Embodiments will be described with respect to an example capture (or encoder/analyser) and playback (or decoder/synthesizer) apparatus or system 150 as shown in FIG. 1.

In the following example the audio signal input is one from a microphone array, however it would be appreciated that the audio input can be any suitable audio input format and the description hereafter details, where differences in the processing occurs when a differing input format is employed.

The system 150 is shown with capture part and a playback (decoder/synthesizer) part.

The capture part in some embodiments comprises a microphone array audio signals input 100. The input audio signals can be from any suitable source, for example: two or more microphones mounted on a mobile phone, other microphone arrays, e.g., B-format microphone or Eigenmike. In some embodiments, as mentioned above, the input can be any suitable audio signal input such as Ambisonic signals, e.g., first-order Ambisonics (FOA), higher-order Ambisonics (HOA) or Loudspeaker surround mix and/or objects.

The microphone array audio signals input 100 may be provided to a microphone array front end 101. The microphone array front end 101 in some embodiments is configured to implement an analysis processor functionality configured to generate or determine suitable (spatial) metadata 104 associated with the audio signals and implement a suitable transport signal generator functionality to generate transport audio signals 102.

The analysis processor functionality is thus configured to perform spatial analysis on the input audio signals yielding suitable spatial metadata 104 in frequency bands. For all of the aforementioned input types, there exists known methods to generate suitable spatial metadata, for example directions and direct-to-total energy ratios (or similar parameters such as diffuseness, i.e., ambient-to-total ratios) in frequency bands. These methods are not detailed herein, however, some examples may comprise the performing of a suitable time-frequency transform for the input signals, and then in frequency bands when the input is a mobile phone microphone array, estimating delay-values between microphone pairs that maximize the inter-microphone correlation, and formulating the corresponding direction value to that delay (as described in GB Patent Application Number 1619573.7 and PCT Patent Application Number PCT/FI2017/050778), and formulating a ratio parameter based on the correlation value.

The metadata can be of various forms and in some embodiments comprise spatial metadata and other metadata. A typical parameterization for the spatial metadata is one direction parameter in each frequency band characterized as an elevation value φ(k, n) value and azimuth value θ(k, n) and an associated direct-to-total energy ratio in each frequency band r(k, n), where k is the frequency band index and n is the temporal frame index.

In some embodiments the parameters generated may differ from frequency band to frequency band. Thus, for example in band X all of the parameters are generated and transmitted, whereas in band Y only one of the parameters is generated and transmitted, and furthermore in band Z no parameters are generated or transmitted. A practical example of this may be that for some frequency bands such as the highest band some of the parameters are not required for perceptual reasons.

In some embodiments microphone array frontend 101 may use a machine learning model to determine the spatial metadata 104 based on the microphone array signals 100, as described in NC322440 and NC322439.

As such the output of the analysis processor functionality is (spatial) metadata 104 determined in time-frequency tiles. The (spatial) metadata 104 may involve directions and energy ratios in frequency bands but may also have any of the metadata types listed previously. The (spatial) metadata 104 can vary over time and over frequency.

In some embodiments the analysis functionality is implemented external to the system 150. For example, in some embodiments the spatial metadata associated with the input audio signals may be provided to an encoder 103 as a separate bit-stream. In some embodiments the spatial metadata may be provided as a set including spatial (direction) index values.

The microphone array front end 101, as described above is further configured to implement transport signal generator functionality, in order to generate suitable transport audio signals 102. The transport signal generator functionality is configured to receive the input audio signals, which may for example be the microphone array audio signals 100 and generate the transport audio signals 102. The transport audio signals may be a multi-channel, stereo, binaural or mono audio signal. The generation of transport audio signals 102 can be implemented using any suitable method.

In some embodiments the transport signals 102 are the input audio signals, for example the microphone array audio signals. The number of transport channels can also be any suitable number (rather than one or two channels as discussed in the examples).

In some embodiments the transport signal 102 are determined based on what kind or type of microphone array signals are input. For example, if the microphone array signals 100 are from a mobile device, the microphone array frontend 101 is configured to select a microphone signal from the left side of the device as the left transport signal and another microphone signal from the right side of the device as the right transport signal. As another example, a dedicated microphone array may be used to capture the audio signals, in which case the transport audio signals 102 may have been captured with dedicated microphones.

In some embodiments the microphone array frontend 101 is configured to apply any suitable pre-processing steps, such as equalization, microphone noise suppression, wind noise suppression, automatic gain control, beamforming and other spatial filtering, ambient noise suppression, and limiter. The transport audio signals 102 may have any kind of directional characteristics, e.g., having omnidirectional or cardioid-like directional patterns.

In some embodiments the capture part may comprise an encoder 103. The encoder 103 can be configured to receive the transport audio signals 102 and the spatial metadata 104. The encoder 103 may furthermore be configured to generate a bitstream 106 comprising an encoded or compressed form of the metadata information and transport audio signals.

The encoder 103, for example, could be implemented as an IVAS encoder, or any other suitable encoder. The encoder 103, in such embodiments is configured to encode the audio signals and the metadata and form an IVAS bit stream. The bitstream 106 comprises the transport audio signals 102 and the spatial metadata 104 in an encoded form. The transport audio signals 102 can, e.g., be encoded using an IVAS core codec, EVS, or AAC encoder (or any other suitable encoder), and the metadata 104 can, e.g., be encoded using the methods presented in GB1811071.8, GB1913274.5, PCT/FI2019/050675, GB2000465.1 (or any other suitable methods).

This bitstream 106 may then be transmitted/stored.

The system 100 furthermore may comprise a player or decoder 105 part. The player or decoder 105 is configured to receive, retrieve or otherwise obtain the bitstream 106 and from the bitstream generate suitable spatial audio signals 110 to be presented to the listener/listener playback apparatus.

The decoder 105 is therefore configured to receive the bitstream 106 and demultiplex the encoded streams and then decode the audio signals and the metadata to obtain the transport signals and metadata. The decoder 105, can in some embodiments be an IVAS decoder (or any other suitable decoder). The decoder 105 may also receive head orientation 108 information, for example from a head tracker, which the decoder may employ when rendering, from the transport audio signals and the spatial metadata, the spatial audio signals output 110 for example a binaural audio signal that can be reproduced over headphones especially in the case of binaural rendering. The decoder 105 and the encoder 103 may be implemented within different devices or the same device.

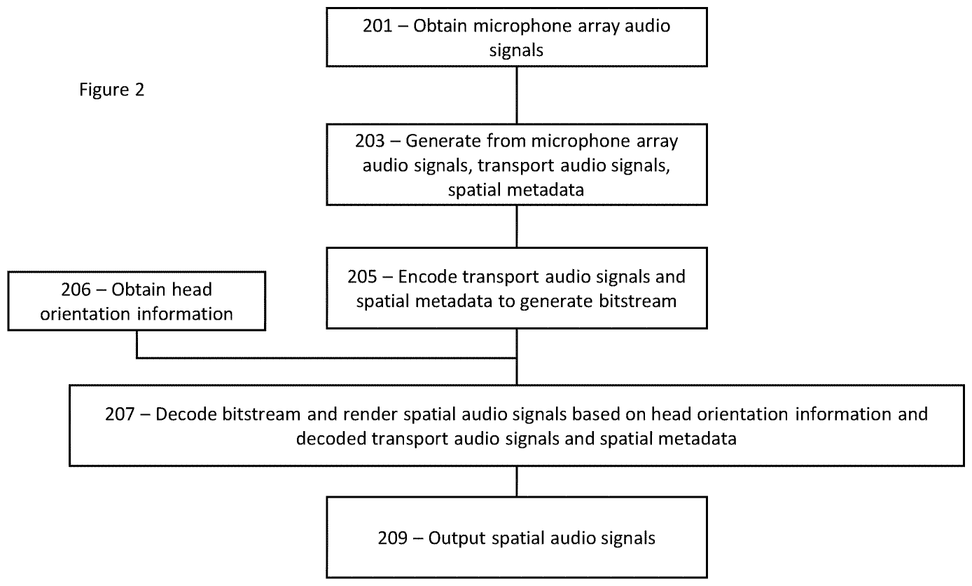

With respect to FIG. 2 is shown a flow diagram of the operations implemented by the system of apparatus shown in FIG. 1.

Thus as shown by 201 the first operation is one of obtaining microphone array audio signals.

Then as shown by 203, there is the step of generating, from microphone array audio signals, transport audio signals and spatial metadata.

The following operation is shown by 205, that of encoding the transport audio signals and spatial metadata to generate a bitstream.

Additionally is shown by 206 the operation of obtaining the head orientation information.

Then as shown by 207 the bitstream is decoded and (binaural) spatial audio signals rendered based on the decoded transport audio signals, spatial metadata and the head orientation information.

Finally output the rendered spatial audio signals as shown by 209.

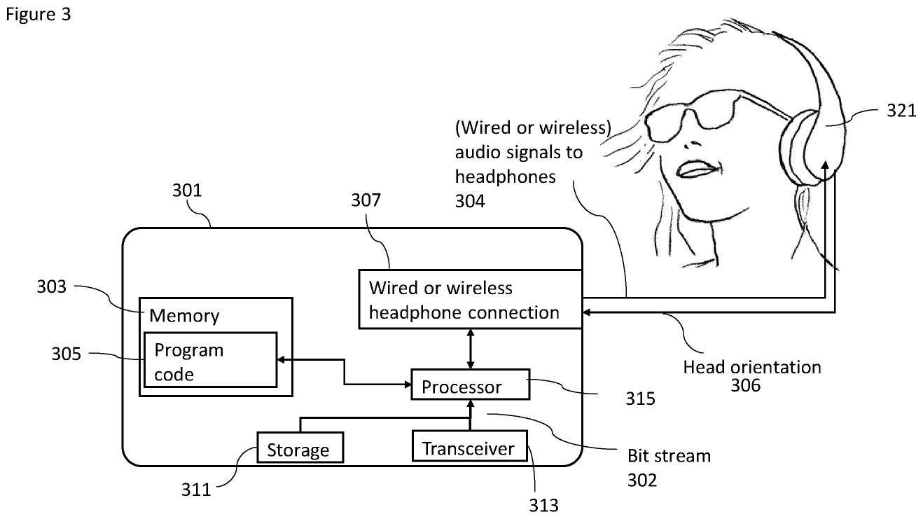

With respect to FIG. 3 is shown an example (playback) apparatus for implementing some embodiments. In the example shown in FIG. 3, there is shown a mobile phone 301 coupled via a wired or wireless connection 307 with headphones 321 worn by the user of the mobile phone 301. In the following the example device or apparatus is a mobile phone as shown in FIG. 3. However the example apparatus or device could also be any other suitable device, such as a tablet, a laptop, computer, or any teleconference device. The apparatus or device could furthermore be the headphones itself so that the operations of the exemplified mobile phone 301 are performed by the headphones.

In this example the mobile phone 301 comprises a processor 315. The processor 315 can be configured to execute various program codes such as the methods such as described herein. The processor 315 is configured to communicate with the headphones 321 using the wired or wireless headphone connection 307. In some embodiments the wired or wireless headphone connection 307 is a Bluetooth 5.3 or Bluetooth LE Audio connection. The connection 307 provides from a processor 315 a (two-channel) audio signal 304 to be reproduced to the user with the headphones 321.

The headphones 321 could be over-ear headphones as shown in FIG. 1, or any other suitable type such as in-ear, or bone-conducting headphones, or any other type of headphones. In some embodiments, the headphones 321 have a head orientation sensor providing head orientation information to the processor 315. In some embodiments, a head-orientation sensor is separate from the headphones 321 and the data is provided to the processor 315 separately. In further embodiments, the head orientation is tracked by other means, such as using the device 301 camera and a machine-learning based face orientation analysis.

In some embodiments the processor 315 is coupled with a memory 303 having program code 305 providing processing instructions according to the following embodiments. The program code 305 has instructions to process the transport audio signals received by the transceiver 313 or retrieved from the storage 311 to a rendered form suitable for effective output to the headphones.

The transceiver 313 can communicate with further apparatus by any suitable known communications protocol. For example in some embodiments the transceiver can use a suitable radio access architecture based on long term evolution advanced (LTE Advanced, LTE-A) or new radio (NR) (or can be referred to as 5G), universal mobile telecommunications system (UMTS) radio access network (UTRAN or E-UTRAN), long term evolution (LTE, the same as E-UTRA), 2G networks (legacy network technology), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs), cellular internet of things (IoT) RAN and Internet Protocol multimedia subsystems (IMS), any other suitable option and/or any combination thereof.

The remote capture apparatus (or encoder device) configured to generate the encoded audio bit stream may be a system similar to or exactly like the apparatus and headphones system shown in FIG. 3. In the capture apparatus or device, the spatial audio signal is an encoded transport audio signal and metadata which is passed to the transceiver or stored in the storage before being provided to the playback device or apparatus processor to be decoded and rendered to binaural spatial sound to be forwarded (with the wired or wireless headphone connection) to headphones to be reproduced to the listener (user).

In some embodiments the device (operating as capture or playback or both) comprises a user interface (not shown) which can be coupled in some embodiments to the processor. In some embodiments the processor can control the operation of the user interface and receive inputs from the user interface. In some embodiments the user interface can enable a user to input commands to the device, for example via a keypad. In some embodiments the user interface can enable the user to obtain information from the device. For example the user interface may comprise a display configured to display information from the device to the user. The user interface can in some embodiments comprise a touch screen or touch interface capable of both enabling information to be entered to the device and further displaying information to the user of the device. In some embodiments the user interface may be the user interface for communicating.

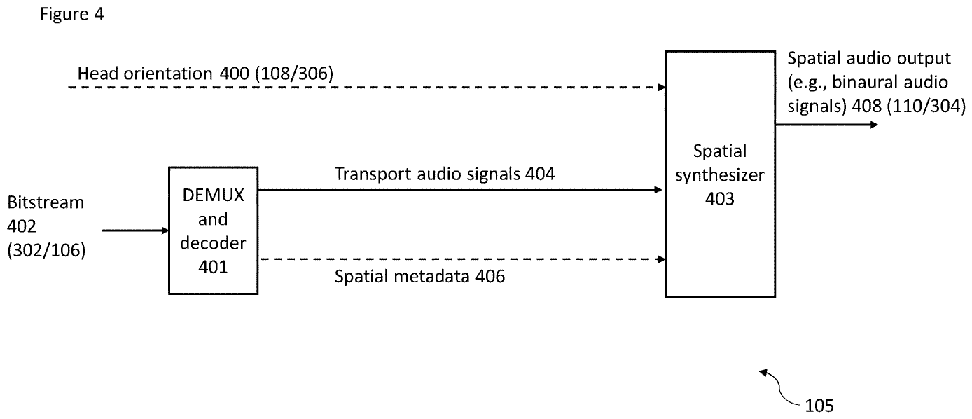

With respect to FIG. 4 is shown a schematic view of the processor 103 with respect to a decoder 105 aspect, where an encoded bit stream is processed to generate spatial audio (for example binaural audio signals) suitable for the headphones 321.

In some embodiments as shown in FIG. 1, the decoder 105 is configured to receive as an input the bitstream 402 (which in FIG. 1 is reference 106 and in FIG. 3 is reference 302), obtained from the capture/encoder apparatus (which can be same device or remote from the apparatus or device.

The decoder 105 can furthermore in some embodiments be configured to receive or otherwise retrieve the head orientation information 400 (which in FIG. 1 is reference 108 and in FIG. 3 is reference 306).

The decoder in some embodiments comprises a demux (demultiplexer) and decoder 401, which demultiplexes and decodes the bitstream 402 into two streams, a transport audio signals 404 and spatial metadata 406. The decoding corresponds to the encoding applied in the encoder 103 shown in FIG. 1. It should be noted that the decoded transport audio signals 404 and the spatial metadata 406 may not be identical to the ones prior to encoding and decoding but are substantially or in principle the same as the transport audio signals 102 and spatial metadata 104 presented in FIG. 1 and described above. Any changes are due to errors introduced in encoding or decoding or in the transmission channel. Nevertheless in the following these signals are referred to using the same term for simplicity.

The transport audio signals 404 and spatial metadata 406 and the head orientation signals 400 can be received by a spatial synthesiser 403, which is configured to synthesize the spatial audio output 408 (which in FIG. 1 is reference 110 and in FIG. 3 is reference 304) in the desired format. For example the output may be binaural audio signals.

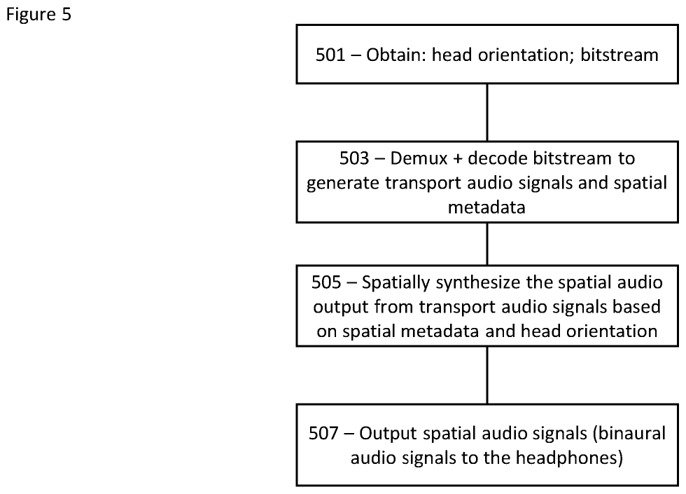

With respect to the FIG. 5 an example flow diagram showing the operations of the processor shown in FIG. 4 is shown according to some embodiments.

Thus the first operation can comprise as shown by 501, obtaining a head orientation signal and the encoded spatial audio bitstream.

Then as shown by 503, the encoded spatial audio bitstream is demultiplexed and decoded to generate transport audio signals and spatial metadata.

Following this as shown by 505 the spatial audio signals are synthesised from the transport audio signals based on the spatial metadata and head orientation information.

Then as shown by 507 the spatial audio signals are output (for example binaural audio signals are output to the headphones).

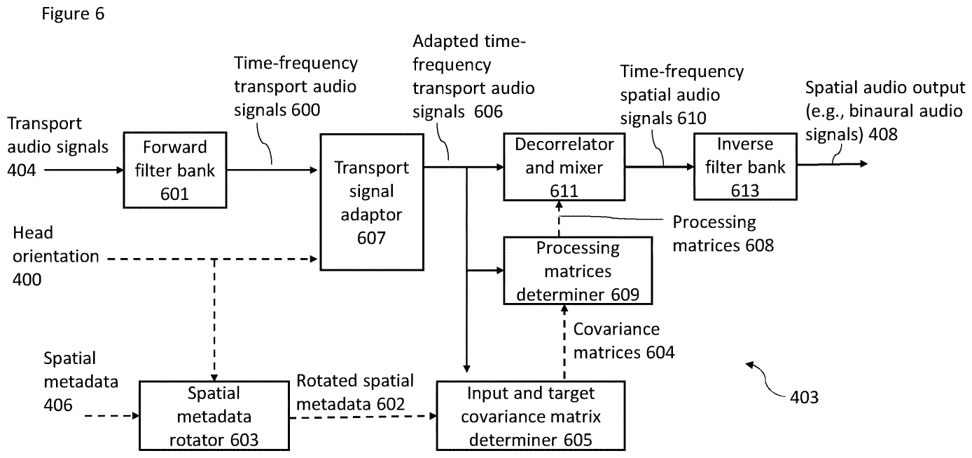

With respect to FIG. 6 the spatial synthesiser 403 of FIG. 4 is shown in further detail. In some embodiments the spatial synthesiser 403 in some embodiments is configured to receive the transport audio signals 404, the head orientation 400 and the spatial metadata 406.

In some embodiments the head orientation 400 is in the form of a rotation matrix that represents the rotation to be performed on direction vectors to compensate for the head rotation. In some embodiments where the head orientation is in another form, such as the conventional yaw, pitch, roll, the head orientation information may be converted to a rotation matrix R (n), where n is the temporal index and angles are given as radians, by

$${c}_{1} = cos ( - roll )$$

$${c}_{2} = cos ( - pitch )$$

$${c}_{3} = cos ( - yaw )$$

$${s}_{1} = sin ( - roll )$$

$${s}_{2} = sin ( pitch )$$

$${s}_{3} = sin ( - yaw )$$

$$R ( n ) = [ \begin{matrix}{c}_{2} {c}_{3} & - {c}_{2} {s}_{3} & {s}_{2} \\ {c}_{1} {s}_{3} + {c}_{3} {s}_{1} {s}_{2} & {c}_{1} {c}_{3} - {s}_{1} {s}_{2} {s}_{3} & - {c}_{2} {s}_{1} \\ {s}_{1} {s}_{3} - {c}_{1} {c}_{3} {s}_{2} & {c}_{3} {s}_{1} + {c}_{1} {s}_{2} {s}_{3} & {c}_{1} {c}_{2}\end{matrix} ]$$

It should be noted that signs and orders of angles are simply a convention based on decided rotation axes and orders of rotations. Other equivalent conversions can be similarly created. In addition, rotation matrices may be obtained from quaternions or direction cosine matrices that also are popular in representing tracked orientation.

In some embodiments the spatial synthesiser 403 comprises a forward-filter bank 601. The transport audio signals 404 are provided to the forward filter bank 601, which transforms the transport audio signals to a time-frequency representation, time-frequency transport audio signals 600. Any filter bank suitable for audio processing may be utilized, such as the complex-modulated quadrature mirror filter (QMF) bank, or a low-delay variant thereof, or the short-time Fourier transform (STFT). Similarly the forward-filter bank 601 can be implemented by any suitable time-frequency transformer. In the example described herein, the forward-filter bank 601 is configured to have 60 frequency bins, and sufficient stop-band attenuation to avoid significant aliasing to occur when the frequency bin signals are processed. In this configuration, all frequency bins can be processed independently from each other, except that some frequency bins share the same spatial metadata. For example, the spatial metadata 406 may comprise spatial parameters in a limited number of frequency bands, for example 5 bands, and each of these bands correspond to a set of one or more frequency bins provided by the forward filter bank 601. Although this example is 5 bands there can be any suitable number of bands, for example the number of frequency bands can be, 8, 12, 18, or 24 bands. The time-frequency transport signals S(b, t, i) can be denoted as

$$s ( b , t ) = [ \begin{matrix}S ( b , t , 1 ) \\ S ( b , t , 2 )\end{matrix} ]$$

either in vector or scalar form, where b is the frequency bin index, t is the time-frequency signal temporal index, and i is the channel index.

In some embodiments the spatial synthesiser 403 comprises a transport signal adaptor 607. The transport signal adaptor 607 is configured to receive the time-frequency transport audio signals 600, along with the head orientation 400 information or signal or data.

The transport signal adaptor 607 is configured to process the time-frequency transport audio signals 600 based on the head orientation 400 data to provide adapted time-frequency transport audio signals 606, which are ‘more favourable’ for the current head orientation for the subsequent spatial synthesis processing. The adapted time-frequency transport audio signals 606 can for example be denoted as:

$$x ( b , t ) = [ \begin{matrix}{S}_{adapted} ( b , t , 1 ) \\ {S}_{adapted} ( b , t , 2 )\end{matrix} ]$$

The adapted time-frequency transport audio signals 606 can be provided to a decorrelator and mixer 611 block, a processing matrices determiner 609, and an input and target covariance matrix determiner 605.

In some embodiments the spatial synthesiser 403 comprises a spatial metadata rotator 603. The spatial metadata rotator 603 is configured to receive the spatial metadata 406 along with the head orientation data 400 (which for this example is in the form of a derived rotation matrix R(n)).

In some embodiments the spatial metadata rotator 603 is configured to convert direction parameter(s) of the spatial metadata to a vector form (where they are not provided in this format).

For example, if the direction parameter is composed of an azimuth θ(k, n) and elevation φ(k, n), where k is the frequency band index, it is converted by

$${v}_{DOA} ( k , n ) = [ \begin{matrix}cos ( θ ( k , n ) ) cos ( φ ( k , n ) ) \\ sin ( θ ( k , n ) ) cos ( φ ( k , n ) ) \\ sin ( φ ( k , n ) )\end{matrix} ]$$

The spatial metadata rotator 603 is configured to rotate the direction vector V_{DOA}(k, n) by the rotation matrix R(n)

$${v}_{DOA , R} ( k , n ) = [ \begin{matrix}{v}_{x} ( k , n ) \\ {v}_{y} ( k , n ) \\ {v}_{z} ( k , n )\end{matrix} ] = R ( n ) {v}_{DOA} ( k , n )$$

In some embodiments the rotated matrix can then be converted into a rotated spatial metadata direction by

$$\begin{matrix}{θ}_{R} ( k , n ) = a tan 2 ( {v}_{y} ( k , n ) , {v}_{x} ( k , n ) ) \\ {ϕ}_{R} ( k , n ) = a tan 2 ( {v}_{z} ( k , n ) , \sqrt{{( {v}_{x} ( k , n ) )}^{2} + {( {v}_{y} ( k , n ) )}^{2}} )\end{matrix}$$

The rotated spatial metadata 602 is otherwise the same as the original spatial metadata 406, but where the rotated direction parameters θ_{R}(k,n) and φ_{R}(k, n) replace the original direction parameters θ(k, n) and φ(k,n). In practice, this rotation compensates for the head rotation by rotating the direction parameters to the opposite direction.

In some embodiments the spatial synthesiser 403 comprises an input and target covariance matrix determiner 605. The input and target covariance matrix determiner 605 is configured to receive the rotated spatial metadata 602 and the adapted time-frequency transport signals 606, which determines the covariance matrices 604 which comprises an input covariance matrix representing the adapted time-frequency transport audio signals 606 and a target covariance matrix representing the time-frequency spatial audio signals 610 (that are to be rendered). The input covariance matrix can be measured from the adapted time-frequency transport signals 606, denoted as a column vector x(b, t), where the row indicates the transport signal channel. This is achieved by

$${C}_{x} ( b , n ) = {\sum }_{t = {t}_{1} ( n )}^{{t}_{2} ( n )} x ( b , t ) {x}^{H} ( b , t )$$

where the superscript H indicates a conjugate transpose and t₁(n) and t₂(n) are the first and last time-frequency signal temporal indices corresponding to frame n (or sub-frame n in some embodiments). In this example, there are four time indices t at each frame n, however there may be more than four or fewer than four time indices. In some embodiments, the covariance matrix is determined for each bin as described above. In other embodiments, it could be also averaged (or summed) over multiple frequency bins, in a resolution that approximates human hearing resolutions, or in the resolution of the determined spatial metadata parameters, or any suitable resolution.

The target covariance matrix in some embodiments is determined based on the spatial metadata and the overall signal energy. The overall signal energy Eₒ(b, n) can be obtained for example as the mean or sum of the diagonal values of Cₓ(b, n). Then, in one example, the spatial metadata consists of the rotated direction parameters θ_{R}(k, n) and φ_{R}(k, n) and a direct-to-total ratio parameter r(k, n). In this example the band index k is the one where the bin b resides.

In some embodiments where the output is a binaural signal, the target covariance matrix can be determined by

$$\begin{matrix}{C}_{y} ( b , n ) = {E}_{o} ( b , n ) r ( k , n ) h ( b , {θ}_{R} ( k , n ) , {φ}_{R} ( k , n ) ) {h}^{H} ( b , {θ}_{R} ( k , n ) , {φ}_{R} ( k , n ) ) \\ + {E}_{o} ( b , n ) ( 1 - r ( k , n ) ) {C}_{d} ( b )\end{matrix}$$

where h(b, θ_{R}(k, n), φ_{R}(k, n)) is a head-related transfer function column vector for bin b, azimuth θ_{R}(k, n) and elevation φ_{R}(k, n), and it is a column vector of length two with complex values, where the values correspond to the HRTF amplitude and phase for left and right ears. In high frequencies, the HRTF values may be also real because phase differences are not needed for perceptual reasons at high frequencies. Obtaining HRTFs for a given direction and frequency is known. C_{d}(b) is the diffuse field binaural covariance matrix, which can be determined for example in an offline stage by taking a spatially uniform set of HRTFs, formulating their covariance matrices independently, and averaging the result.

The input covariance matrix Cₓ(b, n) and the target covariance matrix C_{y}(b, n) can be output as covariance matrices 604.

The above example has considered directions and ratios. However more generally generating a target covariance matrix can be implemented based on GB2572650 where additionally to the directions and ratios, spatial coherence parameters are also described, and furthermore, output types other than binaural output.

In some embodiments the spatial synthesiser 403 comprises a processing matrix determiner 609. The processing matrix determiner 609 is configured to receive covariance matrices Cₓ(b, n) and C_{y}(b, n) 604 and the adapted time-frequency transport audio signals 606 and determines processing matrices M(b, n) and Mᵣ(b, n). The determination of the processing matrices based on the covariance matrices can in some embodiments be based on Juha Vilkamo, Tom Bäckström, and Achim Kuntz. “Optimized covariance domain framework for time—frequency processing of spatial audio.” Journal of the Audio Engineering Society 61.6 (2013): 403-411.

In this method the processing matrices 608 are determined as mixing matrices for processing input audio signals having a measured covariance matrix Cₓ(b, n) such that the output audio signals (the processed input audio signals) attain a determined target covariance matrix C_{y}(b, n).

This method can be employed in various use cases, including generation of binaural or surround loudspeaker signals. In formulating the processing matrices, the method can further implement a prototype matrix which comprises a matrix that identifies the optimization procedure which kind of signals generally are meant for each of the output (with constraint that the output must attain the target covariance matrix). In the example described herein, the generation of such suitable signals has already been implemented in the transport signal adaptor 607, and as such the prototype matrix can, for example, simply be

$$[ \begin{matrix}1 & 0 \\ 0 & 1\end{matrix} ] , or [ \begin{matrix}1 & 0.05 \\ 0.05 & 1\end{matrix} ] .$$

The processing matrices determiner 609 can then be configured to output the processing matrices 608 M(b, n) and Mᵣ(b,n).

In some embodiments the spatial synthesiser 403 comprises a decorrelator and mixer 611. The decorrelator and mixer 611 is configured to receive the adapted time-frequency transport audio signals x(b, t) 606 and the processing matrices 608 M(b, n) and Mᵣ(b,n). The decorrelator and mixer 611 is configured to first process the adapted time-frequency audio signals 606 with decorrelators to generate decorrelated signals x_{D}(b, t). The decorrelator and mixer 611 is then configured to apply a mixing procedure to generate the time-frequency spatial audio signals 610:

$$y ( b , t ) = M ( b , n ) x ( b , t ) + {M}_{r} ( b , n ) {x}_{D} ( b , t )$$

In the above, although not explicitly written in the equation above, the processing matrices may be linearly interpolated between frames n such that at each temporal index of the time-frequency signal the matrices take a step from M(b, n−1) towards M(b, n). The interpolation rate may be adjusted if an onset is detected (fast interpolation) or not (normal interpolation). The time-frequency spatial audio signals 610 y(b, t) can then be output.

In some embodiments the spatial synthesiser 403 comprises an inverse filter bank 613 which is configured to apply an inverse transform corresponding to that used by the forward filter bank 601 to convert the time frequency spatial audio signals 610 to a spatial audio output 408 (which in this example are binaural audio signals).

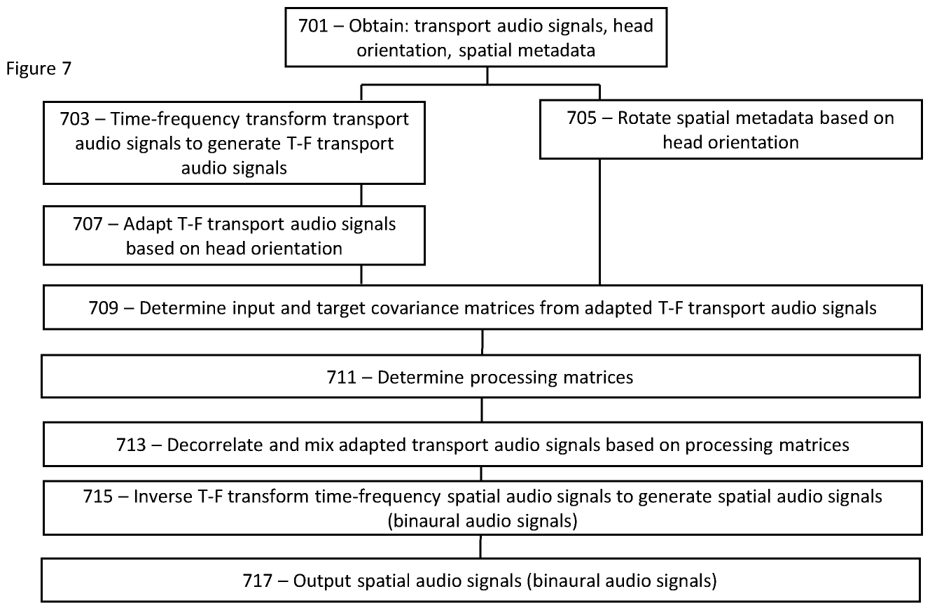

With respect to the FIG. 7 an example flow diagram showing the operations of the spatial synthesiser shown in FIG. 6 is shown according to some embodiments.

Thus the first operation can comprise as shown by 701, obtaining a head orientation signal and the transport audio signals and spatial metadata.

Then as shown by 703, the transport audio signals are time-frequency transformed to generate time-frequency transport audio signals.

Following this as shown by 707 the time-frequency transport audio signals are adapted based on the head orientation information.

Furthermore the spatial metadata are rotated based on the head orientation as shown by 705.

The input and target covariance matrices are determined from the adapted time-frequency audio signals as shown by 709. In some embodiments the target covariance matrices are determined based also on the rotated spatial metadata.

The processing matrices are then determined from the input and target covariance matrices as shown by 711.

The adapted transport audio signals are decorrelated and mixed based on the processing matrices as shown by 713.

Then the time-frequency spatial audio signals are inverse time-frequency transformed as shown by 715.

The spatial audio signals are then output as shown by 717.

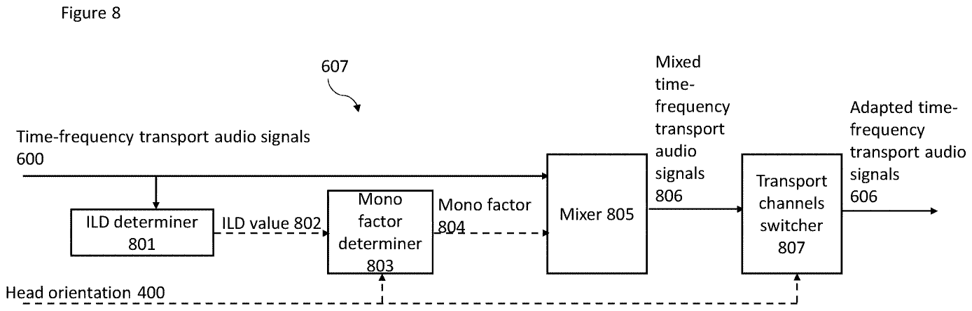

FIG. 8 shows in further detail the transport signal adaptor 607 as shown in FIG. 6. As described above the general concept of the operation of the transport signal adaptor 607 is that when the listener is, for example, looking forward, the transport audio signals are directly suitable for rendering, since the head is essentially in the same pose as the capture device was when capturing the spatial audio. In other words, the sounds that are mostly at left are mostly in the left transport signal, and correspondingly for the sounds at the right.

However, when the listener is, for example, looking at ±90 degrees, the transport audio signals can be adapted for subsequent rendering operations depending on the inter-channel features of the transport signals. In these embodiments when the level difference between the channels is small, both signals likely contain all the sources of the sound scene, and again, there is no modification of the transport audio signals. For example, it may be that the transport audio signals originate from substantially omnidirectional pair of microphones, such as two microphones integrated to the left and right edges of a mobile phone.

However, if the inter-channel level difference is large, one of the channels might not contain at least some of the sources of the sound scene, which would cause reduced quality at the rendering if the rendering would be performed using them when the head orientation is for example ±90 degrees in the yaw direction. For example, the transport audio signals could originate from a pair of cardioid microphones facing opposing directions, and it could be that a relevant sound source (e.g., a talker) is at or near the maximum attenuation direction of one of these cardioid patterns. In this situation, this talker sound is to be rendered at the centre (i.e., front or back, because of head oriented to ±90 degrees yaw). However, the signal of this talker is present only at one of the transport channels. This skews the subsequent rendering operations that generate the left and right binaural channels predominantly from the corresponding left and right transport audio signals.

Thus, in this example, when that talker signal is active, the audio should be cross-mixed to ensure that the particular signal content (talker signal in this example) is present at both channels such that the rendering can be performed without the aforementioned artefacts. Equally when the cross-mixing is not determined to be needed, then it is not performed. For example, when the user is looking at ±90 degrees, but the sound scene contains applause, it should not be cross-mixed. In this case, in this example the channel content is kept fully separated at the transport signal adaptor 607, because then the subsequent spatial audio renderer can generate the suitable incoherence for the applause without the need to substantially resort to decorrelators to revert the loss of inter-channel incoherence that is a side-effect of the cross-mixing processing.

The transport signal adaptor 607 in some embodiments is configured to receive the time-frequency transport audio signals 600, denoted S (b, t, i) where b is the frequency bin index, t is the sample temporal index and i is the channel index, and the head orientation data 400. In some embodiments the transport signal adaptor 607 comprises an inter-channel level difference (ILD) determiner 801. The ILD determiner 801 is configured to receive the time-frequency transport audio signals 600 and determines the inter-channel level differences (ILD) between the channels of the time-frequency transport audio signals. In some embodiments this can be determined by the following operations. First, the energies of the channels are computed, e.g., by

$$E ( b , t , i ) = {\vert S ( b , t , i ) \vert}^{2}$$

These energy values can be smoothed over time, e.g., by

$${E}^{′} ( b , t , i ) = ( 1 - α ) E ( b , t , i ) + α {E}^{′} ( b , t - 1 , i )$$

where α is a smoothing factor (e.g., α=0.95, however, any value may be used) and E′(b, 0, i)=0. In some embodiments, the smoothing can be omitted (i.e., E′(b, n, i)=E (b,n, i)).

The ILD L_{dB}(b, n) can be computed (in decibels), e.g., by

$${L}_{db} ( b , t ) = 10 {log}_{10} \frac{{E}^{′} ( b , t , 1 )}{{E}^{′} ( b , t , 2 )}$$

The ILD value 802 L_{dB}(b, n) can then be output.

In some embodiments the values E′(b, t, i) may be bottom limited by a small value prior to the above operation to avoid numerical instabilities.

In some embodiments the transport signal adaptor 607 comprises a mono factor determiner 803. The mono factor determiner 803 is configured to obtain the ILD value 802 L_{dB}(b, n) and the head orientation 400 and determine how the transport signals should be intermixed to avoid the negative artefacts due to using non-processed transport signals in the head-tracked rendering. The determination is based on the inter-channel features of the transport audio signals and the head orientation. In these embodiments, the inter-channel features are represented by the ILD value 802 to guide or configure the mixing. In other embodiments, other inter-channel features may be used.

The mono factor determiner 803 in some embodiments is configured to determine an ILD-based mono factor by

$${Ξ}_{ILD} ( b , t ) = max ( min ( \frac{\vert {L}_{dB} ( b , t ) \vert - {L}_{limit 0}}{{L}_{limit 1} - {L}_{limit 0}} , 1 ) , 0 )$$

where Lₗᵢₘᵢₜ₁ and Lₗᵢₘᵢₜ₀ are values controlling the mixing (e.g., Lₗᵢₘᵢₜ₁=4 dB and Lₗᵢₘᵢₜ₀=1 dB). In some embodiments other values may also be used. In some embodiments the absolute value of the ILD is used, in other words the mono factor may become larger with larger negative or positive ILDs. Basically, if the absolute ILD is smaller than Lₗᵢₘᵢₜ₀, the ILD-based mono factor gets the value 0, and if the absolute ILD is larger than Lₗᵢₘᵢₜ₁, The ILD-based mono factor gets the value of 1, and, in between, values between 0 and 1.

In some embodiments mono factor determiner 803 is configured to determine an orientation-based mono factor, for example, by

$$\begin{matrix}{Ξ}_{ILD} ( n ) = max ( min ( \frac{{y}_{rot} ( n ) - {y}_{limit 0}}{{y}_{limit 1} - {y}_{limit 0}} , 1 ) , 0 ) \\ {y}_{rot} ( n ) = 1 - \vert {R}_{2 , 2} ( n ) \vert\end{matrix}$$

where R_{2,2}(n) is the second-column, second-row entry of the rotation matrix R(n). This entry of the rotation matrix informs how much the y-axis component of a vector, when processed with the rotation matrix R(n), affects the y-axis component of the provided output vector. In other words, its absolute value is near 1 when the user orientation is aligned with the y-axis, i.e., such that the left and right ears are in line with the y-axis. Therefore, yᵣₒₜ(n) is near 1 (and thus R_{2,2}(n) is near 0) when the user is oriented near to perpendicular to the y-axis, for example, when facing ±90 degrees in yaw. The yₗᵢₘᵢₜ₁ and yₗᵢₘᵢₜ₀ are values controlling the mixing (e.g., yₗᵢₘᵢₜ₁=0.8 and yₗᵢₘᵢₜ₀=0.4, however, also other values may be used). Therefore when yᵣₒₜ(n) is less than yₗᵢₘᵢₜ₀, the orientation-based mono factor gets the value 0, and if yᵣₒₜ(n) is more than yₗᵢₘᵢₜ₁, the orientation-based mono factor gets the value of 1, and, in between, values between 0 and 1. In some embodiments, yᵣₒₜ(n) may be calculated with an applied exponent such as (1−|R_{2,2}(n)|)^{Q} or 1−|R_{2,2}(n)|^{Q} where e can be any number. As this factor is related to rotation and changes in one coordinate are not linear with rotation, it may be that exponential change for the factor provides better quality in some cases. Nevertheless, the value Q=1 is also valid and provides good quality.

Then, the two mono factors (the ILD and orientation based mono factors) are combined, and an overall mono factor Ξ(b, t, i) 804 is formulated for the left and the right channels. For example the combination can be:

$$\begin{matrix}Ξ ( b , t , 1 ) = {Ξ}_{ILD} ( b , t ) {Ξ}_{orient} ( n ) f ( - {L}_{dB} ( b , t ) ) \\ Ξ ( b , t , 2 ) = {Ξ}_{ILD} ( b , t ) {Ξ}_{orient} ( n ) f ( {L}_{dB} ( b , t ) )\end{matrix}$$

where f(x) is an operator that gives value 1 if x is larger than zero, and 0 otherwise. Using the operator causes that a non-zero mono-factor is determined only for the channel that has the lesser energy.

Thus the above Ξ_{ILD} was determined for the sample index (of the time-frequency audio signals) t and Ξₒᵣᵢₑₙₜ is determined using temporal indices n, which was the temporal resolution of the parametric spatial metadata. In other words, there can be multiple sample indices t for a temporal index n. In this case, Ξₒᵣᵢₑₙₜ can also be the same for multiple instances of t when formulating Ξ(b, t, i). In some embodiments the temporal resolutions can be the same.

Hence, the resulting mono factor 804 gets large (1 or near to 1) values only when both the ILD-based mono factor and Orientation-based mono factor have large (1 or near to 1) values. In other words there is a prominent level difference and head rotation for configuring the mixing (for example over a threshold).

In these embodiments the mono factor is non-zero only for the softer channel. It should be noted that the mono factor 804 gets the same values regardless of whether the head is pointing forwards or backwards to a mirror-symmetric direction, as the transport signals can be ‘flipped’ if the user is looking backward (as discussed further below).

In some embodiments the transport signal adaptor 607 comprises a mixer 805. The mixer 805 is configured to receive the mono factor 804 E (b, t, i) and the time-frequency transport audio signals 600 S(b, t, i), which mixes the time-frequency transport audio signals 600 based on the value of the mono factor 804. The mixing can for example be based on the following:

$${S}_{mixed}^{′} ( b , t , i ) = Ξ ( b , t , i ) ( {\sum }_{i = 1}^{{N}_{ch}} S ( b , t , i ) ) + ( 1 - Ξ ( b , t , i ) ) S ( b , t , i )$$

where N_{ch} is the number of channels, typically 2.

Thus, in summary, if the ILD is large and the user head orientation is towards the side directions, mono factor Ξ(b, n, i) for the softer channel has a large (1 or near 1) value, and thus mostly the sum of the left and the right transport signals is used for the softer channel (and the original transport signal for the louder channel). If the user is facing far from the side directions, and/or if the absolute value of the ILD is small, mostly the original transport signals are used for both channels. In other words the mono factor 804 Ξ(b, n, i) is small or zero for both channels. In some embodiments, the transport signals may be multiplied by some factor (e.g., 0.5, or, 0.7, or any other value) before summing to control the loudness of the summed signal, while in some other embodiments they are not multiplied by such factors.

In some embodiments as the mixing can amplify or attenuate the signal in comparison to the original signal (e.g., depending on the phase relationship between the channels), in some embodiments, the resulting signals may be equalized to minimally affect the loudness of the transport signals.

This equalization can be implemented as the following: First, the energy of the mixed signals

$${S}_{mixed}^{′} ( b , t , i )$$

are computed

$${E}_{mixed} ( b , t , i ) = {\vert {S}_{mixed}^{′} ( b , t , i ) \vert}^{2}$$

These may be smoothed over time, e.g., by

$${E}_{mixed}^{′} ( b , t , i ) = ( 1 - α ) {E}_{mixed} ( b , t , i ) + α {E}_{mixed}^{′} ( b , t - 1 , i )$$

where α is a smoothing factor (similarly as was presented above) and

$${E}_{mixed}^{′} ( b , 0 , i ) = 0 .$$

Using the smoothed energies of the original transport signals E′(b, t, i) and the smoothed energies of the mixed transport signals

$${E}_{mixed}^{′} ( b , t , i ) ,$$

equalization values can be computed, e.g., by

$${g}_{eq} ( b , t ) = min ( \sqrt{\frac{{\sum }_{i} {E}^{′} ( b , t , i )}{{\sum }_{i} {E}_{mixed}^{′} ( b , t , i )}} , {c}_{ma x} )$$

where cₘₐₓ is the maximum allowed gain (e.g., cₘₐₓ=4, or any other value) that may be used for limiting the allowed amount of equalization to avoid the excess amplification of, e.g., noises. Furthermore the denominator may be bottom-limited to avoid numerical instabilities.

The mixed time-frequency transport audio signals 806 S_{mixed}(b, t, i) are then finally obtained, for example by

$${S}_{mixed} ( b , t , i ) = {g}_{eq} ( b , t ) {S}_{mixed}^{′} ( b , t , i )$$

In some embodiments the transport signal adaptor 607 comprises a transport channels switcher 807. The transport channels switcher 807 is configured to obtain the resulting mixed time-frequency transport signals 806 S_{mixed}(b, t, i) and the head orientation R(n). The adaptor 607 prior the transport channels switcher 807 handled the situation where the user is oriented to directions such as ±90 degrees, and the transport channels switcher 807 is configured to determine and handle the situation where the user is, for example, facing rear directions (e.g., around 180 degrees yaw). The transport channels switcher 807 is also configured to monitor the R_{2,2}(n) entry of R(n). When the value is below a threshold, for example, below −0.17 (or any other suitable value), that indicates for example that the user has exceeded the head orientation of yaw 90 degrees by approximately 10 degrees. Then, the transport channels switcher is configured to determine that switching is needed. The transport channels switcher 807 is then configured to keep monitoring R_{2,2}(n) until it exceeds 0.17 (or any other suitable value), which means for example that the user's head orientation yaw has returned to the front, by exceeding yaw of 90 degrees approximately by 10 degrees towards the front directions. Then, the transport channels switcher 807 is configured to determine that switching is not needed (anymore).

When the transport channels switcher 807 has determined switching is needed, then it switches the channel order. In other words this switching can be implemented by the following

$${S}_{adapted} ( b , t , i ) = {S}_{mixed} ( b , t , 3 - i )$$

when channel indexing is i=1,2. Otherwise S_{adapted}(b, t, i)=S_{mixed}(b, t, i). When the transport channels switcher 807 changes from switching (mode) to not-switching (mode) or vice versa, it may do it by interpolating. For example, when moving from not-switching to switching mode, it may formulate

$${S}_{adapted} ( b , t , i ) = {g}_{eq} , ( b , t ) ( {g}_{interp} ( t ) {S}_{mixed} ( b , t , 3 - i ) + ( 1 - {g}_{interp} ( t ) ) {S}_{mixed} ( b , t , i ) )$$

where gᵢₙₜₑᵣₚ(t) is the interpolation coefficient that starts from 0 and ends at 1 during the interpolation interval, where the interval could be, for example, 400 samples t. The interpolation may also have an equalizer g_{eq},(b, t) that ensures that the energy of S_{adapted}(b, n, i) is the same as the sum energy of signals gᵢₙₜₑᵣₚ(t)S_{mixed}(b, t, 3−i) and (1−gᵢₙₜₑᵣₚ)S_{mixed}(b, t, i). The equalizer g_{eq},(b, t) may be upper limited to a value such as 4 (or any other suitable value). When the mode is changed from “switching” to “not-switching”, the interpolation can be the same, except that gᵢₙₜₑᵣₚ(t) starts from 1 and reduces to 0 over the 400 samples interval.

The output of the transport channels switcher 807, and of the transport channels adaptor 607 is the adapted time-frequency transport signals 606 S_{adapted}(b, n, i), which for two channels can be denoted as the column vector

$$x ( b , t ) = [ \begin{matrix}{S}_{adapted} ( b , t , 1 ) \\ {S}_{adapted} ( b , t , 2 )\end{matrix} ]$$

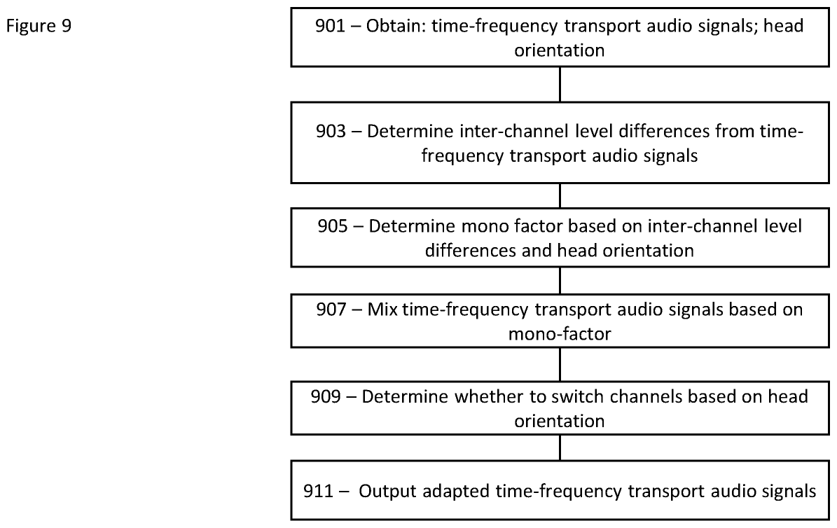

With respect to the FIG. 9 an example flow diagram showing the operations of the transport signal adaptor 607 shown in FIG. 8 is shown according to some embodiments.

Thus the first operation can comprise as shown by 901, obtaining a head orientation signal and the time-frequency transport audio signals.

Then as shown by 903, the inter-channel level differences are determined from the time-frequency transport audio signals.

Following this as shown by 905 the mono factor is determined based on inter-channel level differences and head orientation.

Furthermore time-frequency transport audio signals are mixed based on the mono-factor as shown by 907.

Then the method determines whether to switch channels based on head orientation (and switches them when determined) as shown by 909.

The adapted time-frequency transport audio signals can then be output as shown by 911.

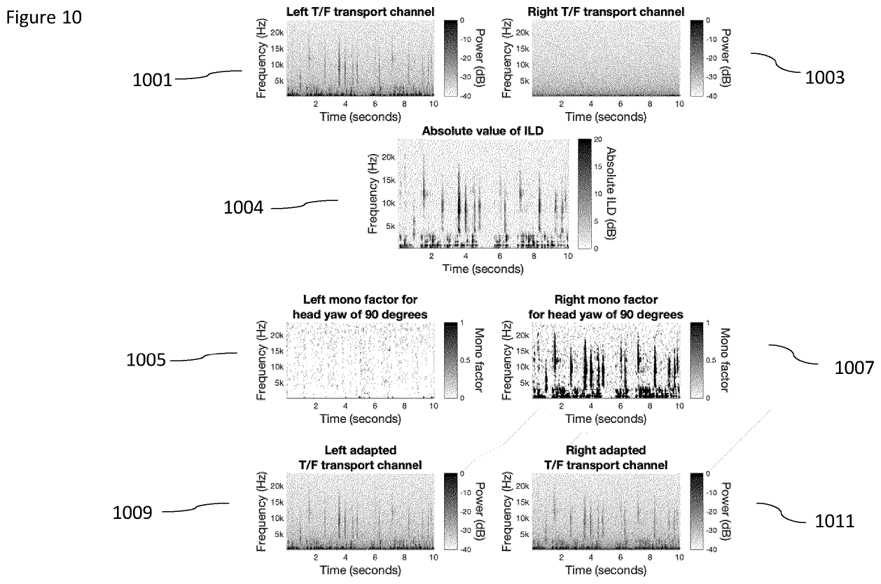

With respect to FIG. 10 is shown examples of the effect of the application of the embodiments as described above. The first row shows the spectrograms of the left 1001 and right 1003 time-frequency transport signals S(b, n, i). The signals are from a simulated capture situation where there is at the horizontal plane pink noise arriving from 36 evenly spaced directions, and a speech sound arriving directly from the left. The sound in this example is captured with two coincident cardioid signals pointing towards left and right. As such, the speech sound is present only at the left capture pattern, and both signals contain the noise/ambience that is partially incoherent between the transport audio signals.

The second row shows the absolute value of the inter-aural level difference 1004 |L_{dB}(b, t)| formulated as described in the foregoing.

The third row shows the mono factor E (b, t, i) for the left 1005 and right 1007 channels assuming head orientation of 90 degrees yaw, formulated as described in the foregoing. It is to be noted that the mono factor is predominant at the softer (right) channel where the speech signal does not originally reside, when that speech signal is active and causes larger absolute ILD values.

The fourth row shows the spectrograms of the adapted time-frequency transport signals 1009, 1011 S_{adapted}(b, n, i), processed as described as in the foregoing. It is thus shown that the processing provides the speech sounds to both channels of adapted time-frequency transport signals. However, as shown in the third row, the mono factor Ξ(b, t, i) is low or zero at the time-frequency regions where the speech is not active, which means that the noise/ambience retains most of its incoherence at the adapted time-frequency transport signals. This is favourable in terms of that the spatial processing based on these signals may render the ambience with zero or minimal amount of decorrelation, which is known to be important for sound quality for certain sound types such as applause.

The proposed embodiments can be applied to any parametric spatial audio stream or audio signal. For example, directional audio coding (DirAC) methods can be applied on Ambisonic signals, and similar spatial metadata can be obtained (e.g., directions and diffuseness values in frequency bands). The transport audio signals can, e.g., be determined from the Wand Y components of the Ambisonics signals by computing cardioids pointing to ±90 degrees. The methods presented above can be applied on such spatial metadata and transport audio signals.

The proposed methods have been described to apply to head-tracked binaural rendering. This is usually understood such that the head of the listener, to which the rendered binaural output is created, is tracked for movements. These movements usually include at least rotations but may also include translations. Although this is the main use case of the proposed methods, it is however not limited to the use case of listener head-tracking. The same proposed methods can be applied to other embodiments if such binaural rendering is implemented with any situation where the rendering is rotated. For example, in immersive codecs such as IVAS or MPEG-I, there can be viewport adjustments which are not related to the listener head orientation. This can be similarly provided to the binaural renderer and may affect the rendering as head-tracking would. In general, an orientation parameter may be provided to the binaural renderer, and the renderer is configured to implement the same steps presented in the proposed methods regardless of the source of the orientation parameter.

The above covariance-matrix-based rendering scheme discussed above is an example and other configurations are also possible. For example, the audio signals could be divided into directional and non-directional parts in frequency bands based on the ratio parameter; then the directional part could be positioned to virtual loudspeakers using amplitude panning; the non-directional part could be distributed to all loudspeakers and decorrelated, and then the processed directional and non-directional parts could be added together, and finally, each virtual loudspeaker is processed with HRTFs to obtain the binaural output. This procedure is described in further detail in DirAC rendering scheme as described in Laitinen, M. V., & Pulkki, V. (2009 October). Binaural reproduction for directional audio coding. In 2009 IEEE Workshop on Applications of Signal Processing to Audio and Acoustics (pp. 337-340). In that situation the usage of the transport signal adaptor can be used for benefit, since the signals of the virtual loudspeakers may be generated so that the left-side virtual loudspeakers are synthesized based on the left channel of the adapted time-frequency transport signals, and similarly for the right-side virtual loudspeakers.

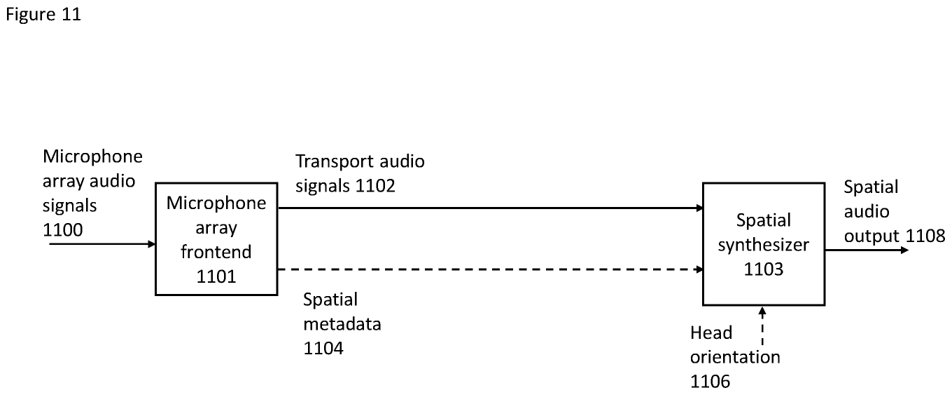

The example embodiments presented above contained encoding and decoding steps. However, in some embodiments, the processing can be applied also in systems that do not involve encoding and decoding. For example with respect to FIG. 11 there is shown a further example embodiment. The input microphone array audio signals 1100 are forwarded to the microphone array frontend 1101 which can be implemented in a manner similar to that discussed with respect to FIG. 1. However, the resulting transport audio signals 1102 and spatial metadata 1104 are forwarded directly to the spatial synthesiser 1103 alongside the head orientation 1106 information. The spatial synthesiser 1103 is configured to operate in the same manner as the spatial synthesiser described above. Hence, the proposed methods can, for example, be also used for direct (i.e., without encoding/decoding) rendering of microphone-array captured sound. It should be noted that in this case (and possibly also in some other embodiments) the transport audio signals 1102 are not necessarily transported anywhere, they are just audio signals being suitable for and used for rendering.

The example embodiments presented above furthermore employ microphone array signals as an input for creating the parametric spatial audio stream (i.e., the transport audio signals and the spatial metadata). However, in some further embodiments, the parametric spatial audio stream can be created using other kind of input. The origin of transport audio signals and the spatial metadata is not significant with respect to employing the embodiments above provided the audio signals and parametric spatial metadata are input to the spatial synthesiser (alongside the head orientation or similar information).

For example, the parametric spatial audio stream can be created from multi-channel audio signals, such as 5.1 or 7.1+4 multi-channel signals, as well as audio objects. For example, WO2019086757A1 discloses methods for determining the parametric spatial audio stream from those input formats. As another example, the parametric spatial audio stream can be created from Ambisonic signals using the DirAC methods.

Thus, the parametric spatial audio stream (i.e., the transport audio signals and the spatial metadata) may originate from any source, and the methods presented herein may be used.

The example embodiments presented above used head orientation as an input. Nevertheless, in some alternative embodiments, head orientation and also head position can be employed. In other words the head can be tracked in 6 degrees-of-freedom (6DoF). An example parametric 6DoF rendering system was presented in GB2007710.8, which operated, e.g., using Ambisonic signals. Similarly, as in the example embodiments presented above, the 6DoF rendering requires creating prototype signals (or similar signals used in the rendering). The methods proposed above can be thus applied also in 6DoF rendering, and where stereo transport audio signals are used.

As presented above, the proposed methods can be used with the IVAS codec. In addition, they can be used with any other suitable codec or system. For example they can be used with the MPEG-I codec. As another example, the present invention could be used in the Nokia OZO audio system, e.g., for rendering binaural audio captured using a microphone array (attached, e.g., in a mobile device).

The example embodiments presented above performed the transport signal adaptor processing in frequency bins. In some alternative embodiments, the processing can be performed in frequency bands, e.g., to optimize the computational complexity of the processing.

In the above examples, the cross-mixing was performed only to the softer of the channels (in frequency bands or bins) in the mixer. In some embodiments, the cross-mixing can be performed to both channels. For example the mixing can be performed by determining the same mono factor for both channels

$$Ξ ( b , t , 1 ) = Ξ ( b , t , 2 ) = {Ξ}_{ILD} ( b , t ) {Ξ}_{orient} ( n )$$

In summary, if the mono factor Ξ(b, n, 1)=Ξ(b, n, 2) has a large value, mostly the sum of the left and the right transport signals is used for both channels, and if it has a small value, mostly the original transport signals are used.

The example embodiments presented above perform the adaptation of the transport signals using a dedicated processing block that resulted in modified audio signals, which were then fed to subsequent processing blocks. In some alternative embodiments, the adaptation of the transport signals can be performed as a part of the processing. Furthermore, in some cases, the rendering of any intermediate signals is optional, but the mixing information can be used to affect the processing values. For example it is possible to modify the prototype matrix used in the rendering. More specifically, in the foregoing formulation it was stated that the prototype matrix can, e.g., be

$$[ \begin{matrix}1 & 0 \\ 0 & 1\end{matrix} ] or [ \begin{matrix}1 & 0.05 \\ 0.05 & 1\end{matrix} ] .$$

However, this matrix is adaptive in some alternative embodiments based on the head orientation and the inter-channel information. For example, the prototype matrix, denoted Q(b, t), can be determined as

$$Q ( b , t ) = [ \begin{matrix}1 & Ξ ( b , t , 1 ) \\ Ξ ( b , t , 2 ) & 1\end{matrix} ]$$

In this example, the transport signal adaptor is not implemented, except for the block transport channel switcher. Alternatively in some embodiments the transport channel switching is included to the matrix Q(b, t) so that when the operating mode is to switch the channels, then

$$Q ( b , t ) = [ \begin{matrix}Ξ ( b , t , 2 ) & 1 \\ 1 & Ξ ( b , t , 1 )\end{matrix} ]$$

In some embodiments when decorrelated sound is needed, it is generated based on the signal Q(b, t)x(b, t).

The above examples employ the inter-channel level difference (ILD) as the inter-channel information based on which and the head orientation the mixing information for the transport audio signals was determined. However, in some embodiments the inter-channel information may, additionally or in place of ILD, utilize the inter-channel correlation (IC) and the inter-channel phase difference (IPD). For example, if the IC value is very high (near 1), then both channels are assumed to have all the relevant signal content even if ILD would have values larger than the exemplified 1 dB. Thus, in this case, the thresholds Lₗᵢₘᵢₜ₁ and Lₗᵢₘᵢₜ₀ could be in these situations be adapted to higher values, for example, double of the values as exemplified in the above embodiments. In another example where other than ILD values are used, if the IC values are high and the IPD values are not zero, this means that the two transport audio signals contain delayed or otherwise out-of-phase signals. Therefore, when cross-mixing the signal between the channels, they could be phase-matched at this mixing procedure based on the IPD value to avoid a frequency dependent effect where some frequencies are amplified or attenuated more due to the phase-differences.

In some alternative embodiments, it is possible to limit the equalization gains g_{eq}(b, t) in alternative or additional ways than just limiting it to some value. For example it is possible to compute a mean equalization factor over the frequency bins b, and limit the values g_{eq}(b, t) so that they may not be cₗᵢₘᵢₜ times larger than the mean value (e.g., cₗᵢₘᵢₜ is 1, or 1.125, or 2, or any suitable value). This, or any other suitable limitation of the equalization values, may be used to prevent boosting the signal too much (in order to avoid audible noises being generated).

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and

I hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device. The term “non-transitory,” as used herein, is a limitation of the medium itself (i.e., tangible, not a signal) as opposed to a limitation on data storage persistency (e.g., RAM vs. ROM).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. A method for generating a spatial output audio signal, the method comprising:
obtaining a spatial audio signal, the spatial audio signal comprising: at least two channel audio signals; and at least one spatial parameter associated with the at least two channel audio signals;
analysing the at least two channel audio signals to determine at least one inter-channel property;
obtaining at least one of an orientation or position parameter;
determining mixing information based on the at least one inter-channel property and the at least one of the orientation or position parameter; and
generating at least two channel output audio signals based on the at least two channel audio signals, the at least one of the orientation or position parameter, and the mixing information.

2. The method as claimed in claim 1, wherein generating the at least two channel output audio signals comprises further based on the at least one spatial parameter associated with the at least two channel audio signals.

3. The method as claimed in claim 1, wherein determining the mixing information further comprises determining the mixing information further based on the at least one spatial parameter.

4. The method as claimed in claim 1, wherein analysing the at least two channel audio signals to determine the at least one inter-channel property comprises generating the inter-channel property based on the at least one spatial parameter associated with the at least two channel audio signals.

5. The method as claimed in claim 1, wherein the at least one spatial parameter comprises:
a spatial parameter associated with respective ones of the at least two audio channel audio signals; and
a spatial parameter associated with the at least two audio channel audio signals.

6. The method as claimed in claim 1, wherein generating the at least one spatial parameter comprises:
generating at least one prototype matrix based on the mixing information; and
rendering the at least two channel output audio signals from the at least two channel audio signals based on: the at least one spatial parameter associated with the at least two channel audio signals; the orientation parameter; the orientation parameter; and the at least one prototype matrix.

7. The method as claimed in claim 2, wherein generating the at least two channel output audio signals based on the at least one spatial parameter comprises:
processing the at least two channel audio signals based on the mixing information to generate at least two channel adapted audio signals; and
rendering the at least two channel output audio signals from the at least two channel adapted audio signals based on: the at least one spatial parameter associated with the at least two channel audio signals; and the orientation parameter.

8. The method as claimed in claim 7, wherein processing the at least two channel audio signals comprises adapting the at least two channel audio signals based on a current orientation and the at least one inter-channel property.

9. The method as claimed in claim 8, wherein adapting the at least two channel audio signals comprises determining a mono factor based on the current orientation and the inter-channel property, the mono factor configured to indicate how the at least two channel audio signals are intermixed to avoid negative artefacts within the at least two channel output audio signals.

10. The method as claimed in claim 1, wherein analysing the at least two channel audio signals comprises analysing the at least two channel audio signals to determine at least one of:
inter-channel level differences between the at least two channel audio signals;
modified inter-channel level differences between the at least two channel audio signals between the at least two channel audio signals, the modifications based on the at least one of the orientation or position parameter;
inter-channel phase differences between the at least two channel audio signals;
inter-channel time differences between the at least two channel audio signals;
inter-channel similarity measures between the at least two channel audio signals; or
inter-channel correlation between the at least two channel audio signals.

11. The method as claimed in claim 7, wherein processing the at least two channel audio signals based on the mixing information comprises mixing the least two channel audio signals based on the inter-channel differences such that an audio component substantially in one of the at least two channel audio signals is mixed to a respective one of the at least two channel adapted audio signals and further at least partially cross-mixed to a further of the at least two channel adapted audio signals.

12. The method as claimed in claim 11, wherein processing the at least two channel audio signals based on the mixing information to generate the at least two channel adapted audio signals further comprises switching at least two of the generated at least two channel adapted audio signals based on the at least one of the orientation or position parameter indicating an orientation towards a rear direction.

13. The method as claimed in claim 1, wherein the at least two channel output audio signals are binaural audio signals.

14. The method as claimed in claim 1, further comprising obtaining at least one of a user head orientation or position and wherein obtaining the at least one of the orientation or position parameter comprises processing the at least one of the user head orientation or position to generate the at least one of the orientation or position parameter.

15-17. (canceled)

18. An apparatus for generating a spatial output audio signal, the apparatus comprising:
at least one processor; and
at least one memory storing instructions that, when executed with the at least one processor, cause the apparatus at least to:
obtain a spatial audio signal, the spatial audio signal comprising: at least two channel audio signals; and at least one spatial parameter associated with the at least two channel audio signals;
analyse the at least two channel audio signals to determine at least one inter-channel property;
obtain at least one of an orientation or position parameter;
determine mixing information based on the at least one inter-channel property and the at least one of the orientation or position parameter; and
generate at least two channel output audio signals based on the at least two channel audio signals, the at least one of the orientation or position parameter, and the mixing information.

19. The apparatus as claimed in claim 18, wherein the instructions, when executed with the at least one processor, cause the apparatus to generate the at least two channel output audio signals further based on the at least one spatial parameter associated with the at least two channel audio signals.

20. The apparatus as claimed in claim 18, wherein the instructions, when executed with the at least one processor, cause the apparatus to determine the mixing information further based on the at least one spatial parameter.

21. The apparatus as claimed in claim 18, wherein the instructions, when executed with the at least one processor, cause the apparatus to generate the at least one inter-channel property based on the at least one spatial parameter associated with the at least two channel audio signals.

22. The apparatus as claimed in claim 18, wherein the at least one spatial parameter comprises:
a spatial parameter associated with respective ones of the at least two audio channel audio signals; and
a spatial parameter associated with the at least two audio channel audio signals.

23. (canceled)

24. The apparatus as claimed in claim 18, wherein the instructions, when executed with the at least one processor, further cause the apparatus to obtain at least one of a user head orientation or position and wherein the obtained at least one of the orientation or position parameter causes the instructions, when executed with the at least one processor, to process the at least one of the user head orientation or position to generate the at least one of the orientation or position parameter.
